(19) United States
(12) Patent Application Publication
(10) Pub. No.: US 2006/0263190 A1
(43) Pub. Date: Nov. 23, 2006

(54) Tracked rotatable cab loader

(76) Inventor: Daniel P. Frieden, Joy, IL (US)

Correspondence Address: Law Office of Jay R. Hamilton, PLC.;NewVentures Center Suite 120, 331 W. 3rd Street, Davenport, IA, 52801, US

(21) Appl. No.: 11/433,821

(22) Filed: May 12, 2006

Related U.S. Application Data
(60) Provisional application No. 60/680,659, filed on May 13, 2005.

(51) Int. Cl. B66C 23/00

(52) U.S. Cl. 414/685

(57) ABSTRACT

The invention as disclosed is configurable for a range of uses, load capacities and sizes. The invention as disclosed is a novel combination of a tracked excavator undercarriage and a cab and loader assembly which rotates. The addition of a tracked excavator undercarriage to a cab and loader assembly which rotates allows for improved access to tight quarters. Operator efficiency is improved as well as visibility during operation. Furthermore, because the cab and loader assembly may be rotated to for material handling in tight quarters, the typical stress and wear on the undercarriage and engine are reduced. The combination of the invention as disclosed with tracks improves access to adverse (muddy or wet) soil conditions as commonly found in construction projects involving installation of underground pipe or material handling through better traction and flotation compared to wheeled loaders. Rotation of the cab and loader assembly versus the undercarriage to accomplish a turning maneuver impacts the ground surface less.

### CROSS REFERENCE TO RELATED APPLICATIONS (NOT APPLICABLE)

The present application claims priority from provisional utility patent application No. 60,680,659 filed May 13, 2005 and incorporated by reference herein.

### FIELD OF THE INVENTION

The present invention relates to improvements in the general field of construction equipment and more particularly to an improved loader tractor for use in applications requiring material handling in tight quarters and or in areas of low traction such as setting pipe or loading trucks in new or green space projects.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to new and useful improvements in self-propelled, front loading loaders. There are many varieties of loaders available in the art. Typically, a loader rides on either tracks or tires and wheels. The wheel loader has both strengths and weaknesses.

A wheel loader is typically very mobile and is best suited for hard, dry surfaces. If a wheeled loader is operated in a soft, wet surface, for example a new construction site right after a rain, it is very likely the wheel loader will get stuck and be inoperable. If the wheel loader does not get stuck during operation, it is very likely that the ground surface under the continuous contact of the wheels will be torn-up and rutted. At the least, this increases expense and inconvenience. At its worst, poor traction and damage to the ground can halt work and or increase the stress on the ground. Furthermore, a wheel loader is inherently limited by its turning radius as to where it can be used. The larger the loader, typically the larger the frame and the larger the turning radius required. Effectively, the larger the load to be lifted, the more space that must be available so that the wheel loader can be used.

An articulating wheel loader has a lower effective turning radius than a straight frame wheel frame loader which increases it usefulness in cramped quarters. An articulating wheel loader still suffers from traction problems in soft soil conditions and still requires more room to turn around than a tracked loader which typically has an effective turning radius of zero.

A tracked loader, however, is not as mobile as a wheel loader and is not well suited for paved surfaces since the tracks may damage the hard surface, especially with the zero radius turns that may be accomplished with a track loader. The track loader is, however, well suited for soft and or wet surfaces which may, for example, be found in a construction site right after a rain.

Because of the improved traction and flotation of a tracked loader, it unlikely the tracked loader will get stuck and become inoperable as with the wheel loader. A tracked loader even though it can be used in these conditions and will not get stuck, may still do great damage to these surfaces when it is turned around. At least, this increases expense and inconvenience. At its worst, poor traction and damage to the ground can halt work and or increase the stress on the ground.

There is therefore a need in the art for a loader that is better suited to work in adverse conditions including upon wet or soft ground while also allowing access to and turning with a load in tight quarters.

### SUMMARY OF THE INVENTION

The invention as disclosed herein addresses the needs of the operator and the art for a loader that is better suited to work in adverse conditions while also allowing access to and turning with a load in tight quarters. The invention as described herein is particularly suited to use in muddy or adverse field conditions. If the operator is in muddy conditions, a track loader will have better traction and flotation than a wheel loader. For example, an operator using a loader tractor to set or lay pipe will often find himself in either muddy or adverse conditions.

Because the invention as described herein allows for a cab and loader assembly that rotates, the amount of turning using the tracks is minimized. This feature reduces the amount of ground torn up by the tracks and also reduces the ruts produced. Because turning the entire machine on the tracks is not required, there is less wear and tear on the actual undercarriage and tracks of the tracked loader tractor.

Furthermore, the operator can use the invention on hard or compact surfaces. Many times a careful operator must navigate these surfaces to properly access a job. This can be accomplished if the operator does not turn the entire machine, i.e. a minimal amount of damage is done to the surface as long as the operator does not turn on the surface. Because the invention described herein includes both tracks and a rotating cab and loader assembly, hard surfaces may be accessed for load manipulation without turning on the tracks. Another advantage found with the present invention is that even in soft or adverse conditions, the disruption produced by the loader tractor tracks is less than for a tracked loader with a non-rotating cab and loader assembly.

This improvement allows the operator to turn or rotate the cab and the loader, not the whole machine. Working in tight quarters the operator may drive the tractor straight into the area via a straight ahead vector, rotate the cab and loader assembly to accomplish a lifting or loading operation and then drive the unit straight out on the same path minimizing surface disruption. Another example wherein this invention may be used is with loading trucks with dirt or rock. An operator could drive up next to the truck, turn or rotate just the cab of the loader and not the whole machine. This feature reduces time to accomplish the dumping action and is faster because there is less wasted motion and energy because the entire unit does not need to turn.

Finally, an added advantage to this invention the features it provides is that there will be less strain on the machine itself by just rotating the cab and loader and not the whole machine. The improved apparatus disclosed herein reduces the wear and tear on both the engine and the undercarriage track assembly of the loader. A cab and loader assembly in combination with track mounted undercarriage that allows for rotation of the cab and loader assembly is described herein and allows for increased traction in adverse conditions, less impact on the environment and better turning in tight conditions. It is therefore an object of the present invention to combine a track mounted undercarriage with a rotating cab and loader assembly. There has long been a need to improve earth moving equipment. Prior art devices and methods include describe various apparatus for attaching blades to buckets of front end loaders and backhoes. A thorough review of this prior art is set forth in U.S. Pat. No. 6,493,967 which is incorporated herein by reference. The present art is an improvement over the cited and referenced prior art found therein.

### BRIEF DESCRIPTION OF THE DRAWINGS

Other objects and features of the invention will become apparent from the following detailed description when read with reference to the accompanying drawings, in which;

FIG. 1 provides a right side view of the present invention with the loader arms in the down position.

FIG. 2 provides a left side view of the present invention with the loader arms in the down position.

FIG. 3 provides a right side view of the present invention with the loader arms extended in the upper or lifting position.

FIG. 4 provides a left side view of the present invention with the loader arms extended in the upper or lifting position.

FIG. 5 provides a front perspective view of the present invention partially rotated with the loader arms down.

FIG. 6 is a side view of another embodiment of the present invention wherein a loader arm has been placed upon an excavator having a rotatable cab and tracks.

FIG. 7 is a side view of another embodiment of the present invention wherein a loader bucket has been attached to an excavator having a hydraulically actuated stick.

### DETAILED DESCRIPTION—ELEMENT LISTING

| Description | Element No. |
|---|---|
| Bucket | 1 |
| Loader bucket hydraulic | 2 |
| cylinder | |
| Loader Frame | 3 |
| Primary Loader Arms | 4 |
| Loader Lifting Cylinder | 5 |
| Bucket Arm | 6 |
| Bucket Rod | 7 |
| Bucket Arm Cross Member | 8 |
| Tracked Rotatable Cab Loader | 9 |
| Front working light | 10 |
| Rear working light | 11 |
| Operators Cab | 12 |
| Upper Cab Assembly | 13 |
| Fuel Tank | 14 |
| Air Intake | 15 |
| Exhaust Pipe | 16 |
| Operator Safety Rail | 17 |
| Operator's steps | 18 |
| Operator Catwalk | 19 |
| Engine Compartment | 20 |
| Intentionally Blank | 21 |
| Intentionally Blank | 22 |
| Excavator stick | 23 |
| Excavator | 24 |
| Loader Arms | 25 |
| Upper Turret | 26 |
| Lower Turret | 27 |
| Undercarriage assembly | 28 |
| Intentionally Blank | 29 |
| Tracks | 30 |
| Track roller/idler | 31 |
| Centered Loader Arm | 32 |

### DETAILED DESCRIPTION OF THE INVENTION

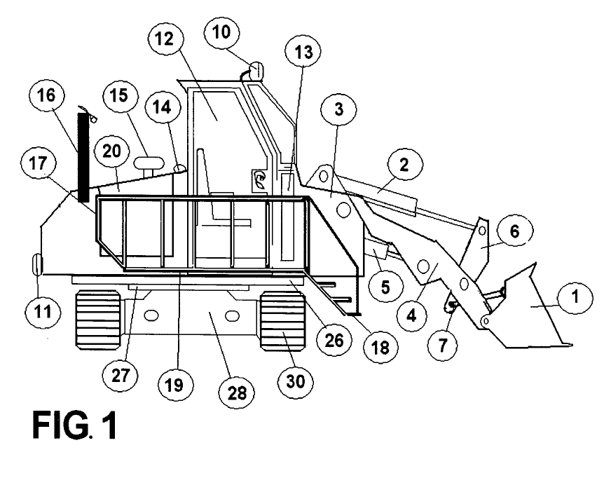

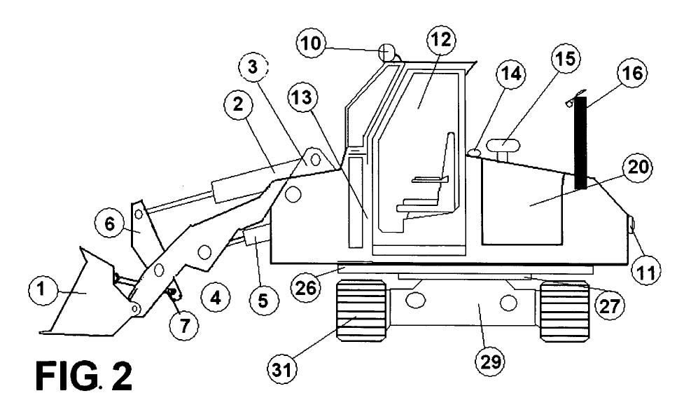

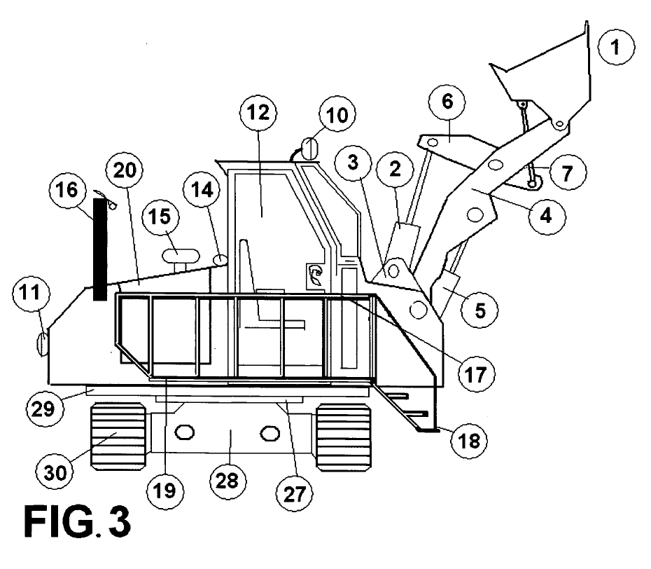

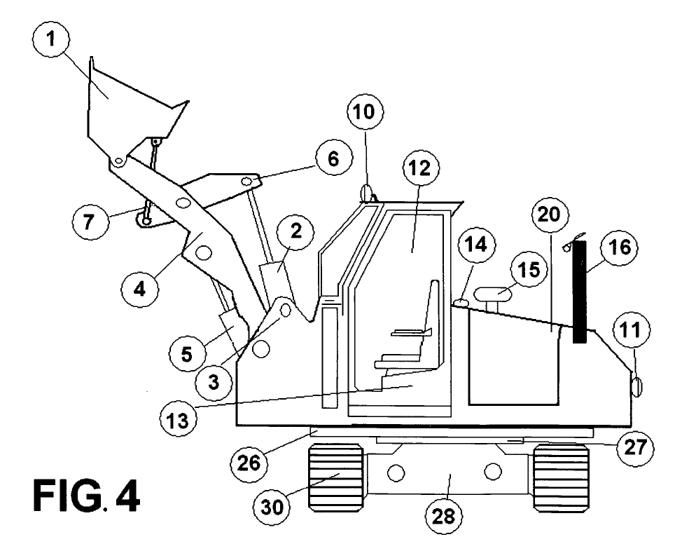

FIG. 1 provides a right side view of the present invention with the loader arms 4 in the down position. FIG. 2 provides a left side view of the present invention with the loader arms 4 in the down position. FIG. 3 provides a right side view of the present invention with the loader arms 4 extended in the upper or lifting position. FIG. 4 provides a left side view of the present invention with the loader arms 4 extended in the upper or lifting position.

As shown in FIG. 1, the present invention is composed of three main groups of interacting sub-assemblies. The first sub-assembly is composed of the parts or elements that support the loader assembly. The loader assembly is comprised of a bucket 1 attached to a set of primary loader arms 4. The loader bucket 1, as shown, pivots and is one means of scooping or carrying a load, as recited in the claims. The lower end of the primary loader arms 4 are connected to the loader frame 3 which is mounted to the upper cab assembly 13. The lower end of the loader hydraulic lifting cylinders 5 are also connected to the loader frame 3 with the opposite end connected to the primary loader arms 4 to allow or motivate the primary loader arms 4 to move up and down and thus move a load as may be found in bucket 1. The pitch and or level of loader bucket 1 is controlled by the loader bucket hydraulic cylinder 2 which is mounted between the bucket arm cross member 8 and the bucket arm 6. The bucket arm cross arm member 8 is mounted across and between the primary loader arms 4 to and for support of the primary loader arms 4. Extension or retraction of the bucket hydraulic cylinder 2 engages and moves the bucket arm 6 thereby moving bucket rod 7 which pivots bucket 1 which is mounted pivotably mounted on the ends of primary loader bucket arms 4. The individual elements of the loader frame and hydraulic system, as shown, are one means of supporting and operating a loader bucket attached to a tracked rotatable cab loader, as recited in the claims.

The second sub-assembly is composed of the parts or elements that support the upper cab assembly 13 including the loader frame 3 upon which the loader assembly is mounted. The upper cab assembly includes the operator cab 12 which houses the main controls and protects the operator. Lights are typically mounted on the front 10 and rear 11 sides of the operator cab assembly 13, respectively. As shown in FIGS. 1-4, the upper cab assembly 13 includes and encloses the engine compartment 20 through which engine air intake 15 and exhaust 16 project outside the upper cab assembly 13. Typically, fuel tank 14 is also mounted upon the upper cab assembly 13. FIGS. 1 and 3 also show the typical safety equipment found on modern construction equipment including operator steps 18 for access by the operator to the operator catwalk 19 and the operator safety rail 17 to protect against falls during both access or egress of the operator cab 12. FIGS. 2 and 4 show the left side view of the tracked loader tractor and do not include the normal safety equipment for better clarity.

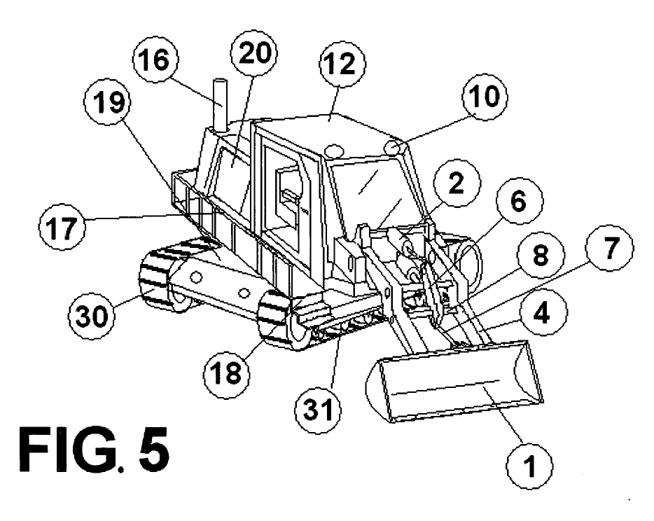

As shown in FIGS. 1-4, the third and final sub-assembly of the present invention is made up of the undercarriage assembly 28. The upper cab assembly 13 of the present invention as shown in FIGS. 1-4 is fixedly mounted upon upper turret 26 which is pivotably mounted upon the lower turret 27. The tracks 30 and track system are mounted to undercarriage assembly 28 upon which lower turret 27 is fixedly mounted to carry the entire tracked loader. The pivotably mounting of the upper turret 26 to the lower turret 27 allows the upper cab assembly 13 and loader assembly to turn and rotate while the tracks 30 and undercarriage assembly 28 remain fixed. Although not shown, those practiced in the arts will understand that the motive force to rotate the upper cab assembly 13 may be supplied by any one of the systems normally found on equipment of this type including hydraulic, hydrostatic and mechanical means such as gears. FIG. 5 highlights the rotatable relationship between the upper cab assembly 13 and undercarriage assembly 28. The upper and lower turret arrangement, 26 and 27, as shown are one means of allowing rotation of the cab assembly to increase loader performance, as recited in the claims.

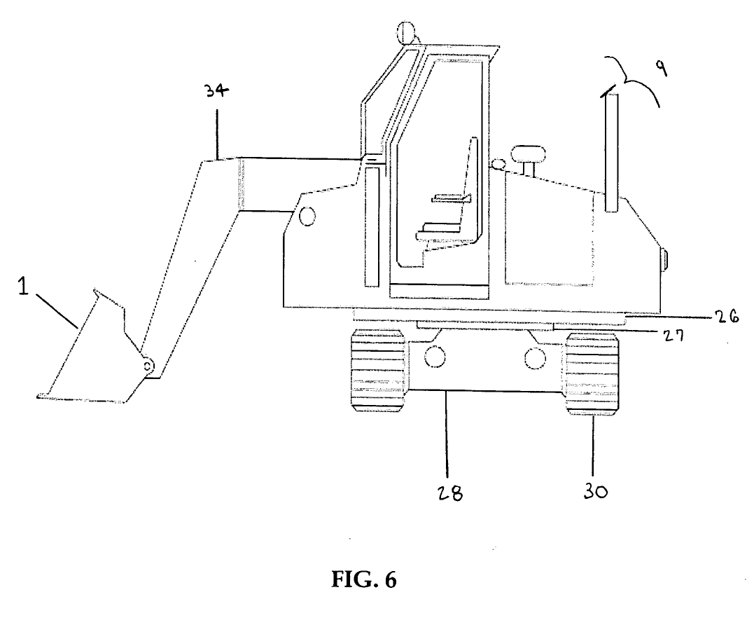

FIG. 6 illustrates a perspective view of another embodiment of the present invention. In this embodiment, the invention may be practiced through a conversion kit allowing an existing excavator 24 to be converted to a tracked rotatable cab loader 9. To implement this embodiment, as shown in FIG. 6, the “stick” of the excavator 23 is detached and replaced with a set of loader arms 6. These loader arms have their own hydraulic system comprising hydraulic cylinders 5 to lift the loader arms 4 and hydraulic cylinders to control the loader bucket 1 attached to the loader arms 4. For clarity, in FIG. 6, the hydraulic cylinders have been removed. An alternative embodiment of this embodiment would be to replace the double loader arm configuration with a centered single arm 32 configuration. In either embodiment, it would be preferred for the loader frame 3 to be coupled to the excavator frame or body with securement means allowing rapid detachment or re-attachment such as pins or bolts although more permanent means such as castings or welding could be used. Attachment systems such as this are known by those practiced in the arts as exemplified in U.S. Pat. No. 3,243,066 issued to C. W. Gardner et al. which is incorporated herein by reference.

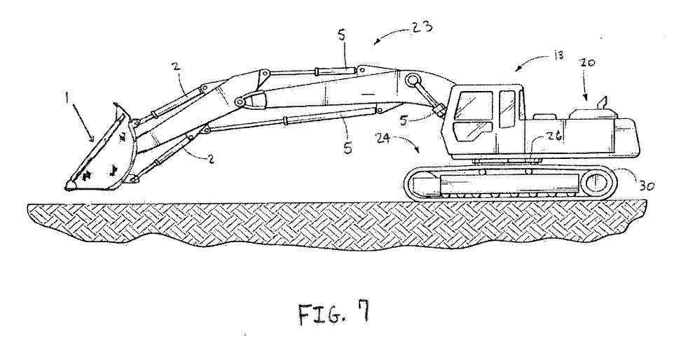

Another version of this embodiment is shown in FIG. 7. In this embodiment, a pivoting loader bucket 1 having hydraulically controllable has been coupled to the end of an existing excavator stick 23. The open side of the loader bucket 1a faces away from the excavator 23 allowing the excavator 23 to be used as a loader. The hydraulics of the loader bucket 1 would couple to the existing hydraulic system of the excavator 23 and excavator stick 23. Hydraulic systems such as this type are known by those practiced in the arts as exemplified by U.S. Pat. Nos. 4,206,688 and 3,800,670 which are incorporated herein by reference.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. An improved tracked loader comprising:
a. A frame;
b. An engine, said engine mounted on said frame;
c. An undercarriage assembly;
d. A lower turret, said lower turret mounted upon said undercarriage assembly;
e. An upper turret, having first and second sides; said first side of said upper turret mounted upon and engaged with said lower turret to allow rotation of said upper turret; said second side of said upper turret mounted to and engaged with said frame;
f. A set of tracks, said tracks mounted to said undercarriage assembly;
g. A track drive system, said track drive system coupled between and with said engine and said set of tracks through said undercarriage assembly for powered motivation of said set of tracks;
h. A hydraulic system, said hydraulic system located on said frame and powered by said engine and wherein said hydraulic system is coupled to said upper turret for controlled powered rotation;
i. A loader frame having a bucket, said loader attached to said frame and coupled with said hydraulic system to allow hydraulic operation of loader bucket.

2. A tracked loader as described in claim 1, wherein said loader frame further comprises two members in parallel connection to said bucket.

3. A tracked loader as described in claim 1, wherein said loader frame further comprises a single member attached at a first end to a the center of the loader frame and at a second end to a loader bucket.

4. A tracked loader as described in claim 2, wherein the opening of said loader bucket faces away from said tracked loader during operation.

5. A tracked loader as described in claim 3, wherein the opening of said loader bucket faces away from said tracked loader during operation.

6. A combination of cooperating elements offered as a kit for converting an excavator having tracks, a hydraulic system and a rotatable cab to a loader comprising:
a. A pivotable loader bucket; and,
b. A loader arm having a hydraulic system, wherein said first end of said loader arm may be detachably mounted to said excavator frame and said second end may be detachably mounted to said loader bucket, said hydraulic system of said loader arm to be coupled to said excavator hydraulic system.

7. The combination of cooperating elements offered as a kit according to claim 6 further comprising a set of loader arms having a hydraulic system, wherein said first end of said loader arms may be detachably mounted to said excavator frame and said second end may be detachably mounted to said loader bucket, said hydraulic system of said loader arm to be coupled to said excavator hydraulic system.

8. The kit of claim 6 or 7 wherein the opening of said loader bucket faces away from said tracked loader during operation.

9. An apparatus for earth moving comprising:
a. An operator control cab;
b. A frame means;
c. A power means, said power means mounted to said frame means;
d. An operator control cab rotation means;
e. A drive means;
f. A hydraulic system;
g. A ground engagement means, wherein said drive means is coupled between and with said power means and said set of ground engagement means through said undercarriage assembly for powered motivation of said ground engagement means;
h. A scooping and loading means, said scooping and loading means attached to said frame and coupled with said hydraulic means for scooping and loading earth.

10. An apparatus for earth moving as described in claim 9, wherein said apparatus further comprises two members in parallel connection between said frame means and said scooping and loading means.

11. An apparatus for earth moving as described in claim 9, wherein said ground engagement means are tracks.

12. An apparatus for earth moving as described in claim 9, wherein the opening of said scooping and loading means faces away from said operator control cab means during operation.
